(19) United States
(12) Patent Application Publication
(10) Pub. No.: US 2019/0145278 A1
(43) Pub. Date: May 16, 2019

(54) Turbocharger

(71) Applicant: MAN Energy Solutions SE, Augsburg (DE)

(72) Inventor: Sven BRANDT, Muenchen (DE)

(21) Appl. No.: 16/191,562

(22) Filed: Nov. 15, 2018

(30) Foreign Application Priority Data
Nov. 16, 2017 (DE) 10 2017 126 935.5

(51) Int. Cl. F01D 25/16; F01D 25/18; F02C 6/12

(52) U.S. Cl. CPC F01D 25/164; F01D 25/168; F01D 25/18; F05D 2260/98; F05D 2240/52; F05D 2220/40; F02C 6/12

(57) ABSTRACT

A turbocharger, with a turbine housing, a compressor housing and a bearing housing that is arranged between the turbine housing and the compressor housing, wherein both the turbine housing and the compressor housing are connected to the bearing housing, with at least one bearing, via which the shaft is mounted in the bearing housing, wherein the respective bearing comprises a bearing bush that is mounted in the bearing housing in a rotationally fixed manner, wherein between the bearing bush and the bearing housing a radially outer lubricating gap and between the bearing bush and the shaft a radially inner lubricating gap are formed, and wherein the bearing bush of the respective bearing is aligned in the radial direction relative to the bearing housing via at least one spring element.

### 1. FIELD OF THE INVENTION

The present invention relates to a turbocharger and more specifically to a turbocharger with a radially aligned bearing bush.

### 2. BACKGROUND OF THE INVENTION

From DE 10 2013 002 605 A1 the content of which is hereby incorporated herein in its entirety, the fundamental construction of a turbocharger is known. A turbocharger comprises a turbine, in which a first medium is expanded. Furthermore, a turbocharger comprises a compressor, in which a second medium is compressed, namely utilizing energy extracted in the turbine during the expansion of the first medium. The turbine of the turbocharger comprises a turbine housing and a turbine rotor. The compressor of the turbocharger comprises a compressor housing and a compressor rotor. Between the turbine housing of the turbine and the compressor housing of the compressor a bearing housing is positioned, wherein the bearing housing is connected on the one side to the turbine housing and on the other side to the compressor housing. In the bearing housing, a shaft is mounted via which the turbine rotor is coupled to the compressor rotor.

From practice it is known that the shaft, which couples the turbine rotor of the turbine to the compressor rotor of the compressor, is mounted in the bearing housing via at least one bearing. The respective bearing of the bearing housing for mounting the shaft comprises a bearing bush, which is either mounted in the bearing housing in a rotationally fixed manner or which can rotate in the bearing housing. The present invention relates to a turbocharger, in the case of which in the region of at least one bearing of the bearing housing the bearing bush of the bearing is mounted in the bearing housing in a rotationally fixed manner. Between the bearing housing and the bearing bush, a radially outer lubricating gap and between the bearing bush and the shaft, a radially innerlubricating gap is formed. The radially outer lubricating gap formed between the bearing housing and the bearing bush is also described as squeeze film damper.

In the case of turbochargers known from practice, an exact alignment of the bearing bush relative to the bearing housing proves to be difficult, as a result of which an exact gap dimension accuracy both in the region of the radially outer lubricating gap and also in the region of the radially inner lubricating gap is not possible during the operation of the turbocharger. Because of this, the lubrication can be impaired in the region of the radially outer and in the region of the radially inner lubricating gap.

### SUMMARY OF THE INVENTION

According to the present invention, the bearing bush of the respective bearing is aligned in the radial direction relative to the bearing housing via at least one spring element. The or each spring element not only serves for the radial alignment of the bearing bush relative to the bearing housing but also for damping the bearing bush during the operation. Both in the region of the radially outer lubricating gap and also in the region of the radially inner lubricating gap the lubricating function can be optimally ensured.

Preferentially, the respective spring element is inserted into a groove in the bearing housing, wherein the respective spring element supports itself on the one side on a groove base of the groove of the bearing housing and on the other side on a radially outer surface of the bearing bush. This embodiment is particularly simple in design and allows an exact alignment of the bearing bush relative to the bearing housing.

According to an advantageous further development of the invention, the bearing bush of the respective bearing is aligned in the radial direction relative to the bearing housing via multiple spring elements, wherein a first spring element acts on a first axial end section and a second spring element on a second axial end section of the bearing bush. This way the bearing bush can be exactly aligned in the radial direction relative to the bearing housing, and the bearing bush can be additionally dampened.

Preferentially, the radially outer lubricating gap can be supplied with lubricating oil from at least one first line which opens into the radially outer lubricating gap between the grooves receiving the spring elements. Accordingly, the radially outer lubricating gap can be optimally supplied with oil, namely via at least one first line which extends between the spring elements or the grooves receiving the spring elements.

### BRIEF DESCRIPTION OF THE DRAWINGS

Exemplary embodiments of the invention are explained in more detail by way of the drawing in which:

FIG. 1 is a cross sectional view through a turbocharger according to the prior art;

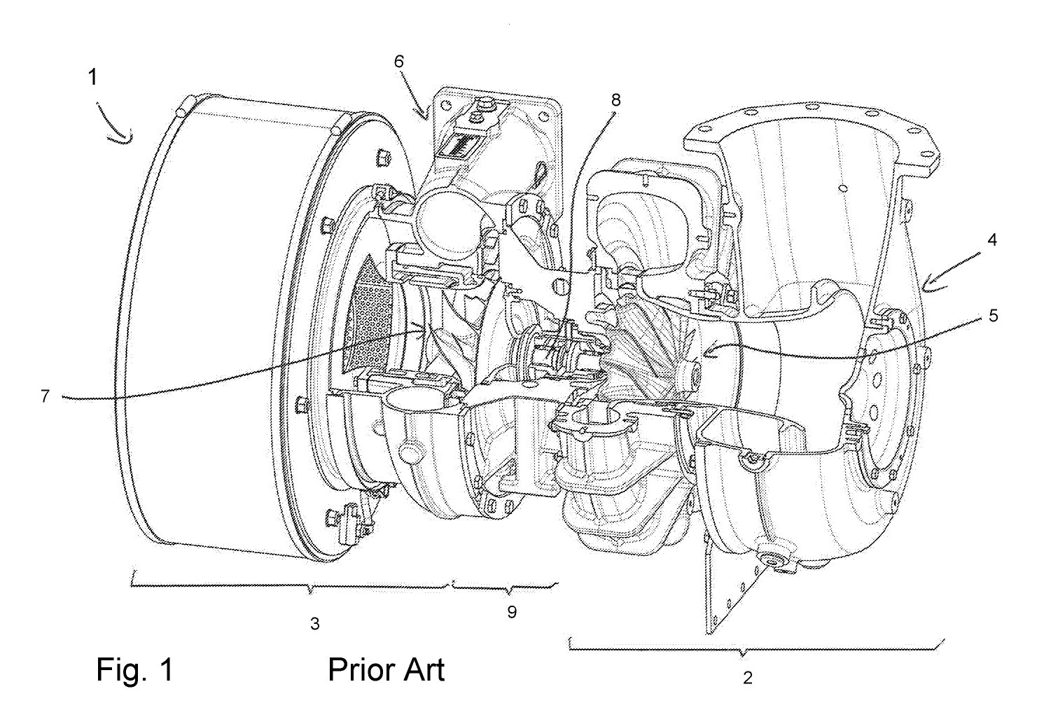

FIG. 2 is a cross sectional view through a first turbocharger according to the invention in the region of a bearing of the bearing housing; and

FIG. 3 is a cross sectional view through a second turbocharger according to the invention in the region of a bearing of the bearing housing.

### DETAILED DESCRIPTION OF THE PRESENTLY PREFERRED EMBODIMENTS

A turbocharger 1 comprises a turbine 2 for expanding a first medium, in particular for expanding exhaust gas of an internal combustion engine. Furthermore, a turbocharger 1 comprises a compressor 3 for compressing a second medium, in particular charge air, namely utilizing energy extracted in the turbine 2 during the expansion of the first medium.

The turbine 2 comprises a turbine housing 4 and a turbine rotor 5. The compressor 3 comprises a compressor housing 6 and a compressor rotor 7. The compressor rotor 7 is coupled to the turbine rotor 5 via a shaft 8, which is mounted in a bearing housing 9, wherein the bearing housing 9 is positioned between the turbine housing 4 and the compressor housing 5 and is connected to both the turbine housing 4 and the compressor housing 5.

The shaft 8, which couples the turbine rotor 5 of the turbine 2 to the compressor rotor 7 of the compressor 3, is mounted in the bearing housing 9, namely via at least one bearing 10 of the bearing housing 9. Preferentially, the bearing housing 9 comprises two bearings 10 for mounting the shaft 8, wherein a first bearing 10 is connected to a section of the shaft 8 facing the turbine rotor 5 and wherein a second bearing 10 acts on an end of the shaft 8 facing the compressor rotor 7.

The respective bearing 10 comprises a bearing bush 11, which is mounted in the bearing housing 9 in a rotationally fixed manner. A bearing bush 11 mounted in the bearing housing 9 in a rotationally fixed manner or mounted on the bearing housing 9 in a rotationally fixed manner is an assembly on the housing side, on the stator side which is stationary while the shaft 8 rotates.

Between the bearing bush 11 mounted in the bearing housing 9 in a rotationally fixed manner and the bearing housing 9, a radially outer lubricating gap 13 and between the bearing bush 11 and the shaft 8 a radially inner lubricating gap 14 are formed.

The bearing bush 11 is inserted into a recess in the bearing housing 9 and adjoins with an axial end a stop formed by the bearing housing 9. On the opposite axial end of the bearing bush 11, a cap 12 is positioned, which together with the bearing housing 9 provides the axial positioning of the bearing bush 11 in the bearing housing 9.

The bearing bush 11 of the respective bearing 10, which is mounted in the bearing housing 9 in a rotationally fixed manner, is aligned relative to the bearing housing 9 in the radial direction via at least one spring element 15. The respective spring element 15 is inserted into a groove 16 in the bearing housing 9, wherein the respective spring element 15 supports itself on the one side on a groove base of the respective groove 16 of the bearing housing 9 and on the other side on a radially outer surface of the bearing bush 11.

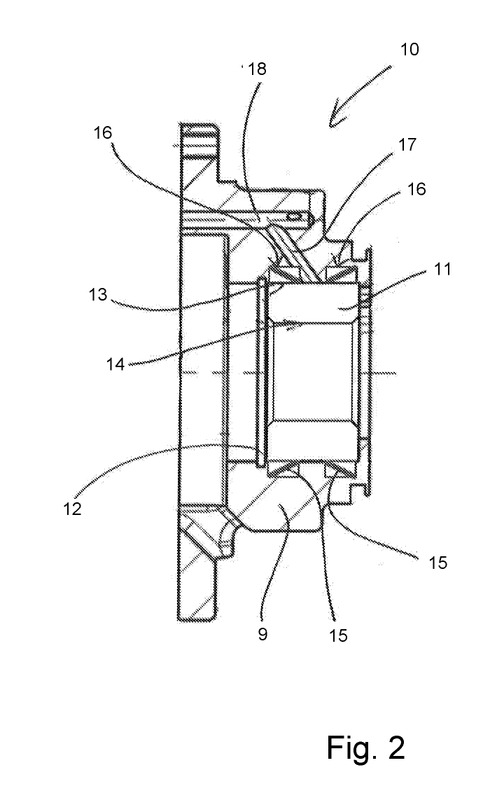

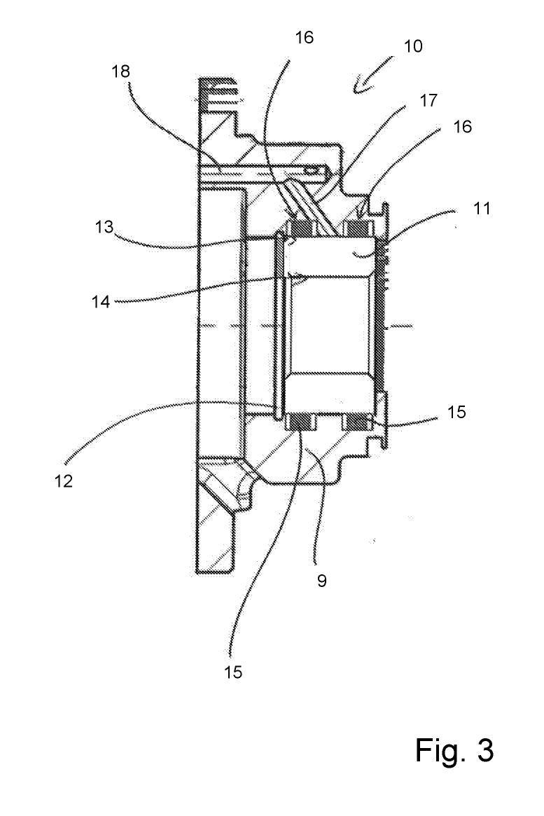

In the shown preferred exemplary embodiments of FIGS. 2 and 3, the bearing bush 11 of the respective shown bearing 10 is aligned in the radial direction relative to the bearing housing 9 via multiple spring elements, in particular via two spring elements 15, wherein a first spring element 15 act on a first axial end section and a second spring element 15 on a second axial end section of the shown bearing bush 11, and wherein each spring element 15 is inserted or received in a corresponding groove 16 of the bearing housing 9. In the exemplary embodiment of FIG. 2, the shown spring elements 15, which are inserted in the respective groove 16 of the bearing housing 9, are circumferential disc springs in the respective groove 16. In the exemplary embodiment of FIG. 3, the spring elements are, by contrast, circumferential blade springs.

With the present invention, an exact positioning of the bearing bush 11 of a bearing 10 in the bearing housing 9 of the turbocharger 1 is possible with simple design expenditure, wherein both in the region of the radially outer lubricating gap 13 as well as in the region of the radially inner lubricating gap 14 the lubricating function can be ensured. Because of the fact that the spring elements 15 align the respective bearing bush 11 not only in the radial direction relative to the bearing housing 9 but rather also dampen the bearing bush 11 during the operation of the turbocharger 1, the radially outer lubricating gap 13 no longer has to assume the function of a squeeze film damper, but the radially outer lubricating gap 13 merely serves for the lubricating oil supply for the inner lubricating film.

In the shown exemplary embodiment, the radially outer lubricating gap 13 can be supplied with lubricating oil via at least one first line 17 emanating from an oil supply main line 18, wherein the or each first line 17 opens into the radially outer lubricating gap 13 between the grooves 16 receiving the spring elements 15. Starting out from the radially outer lubricating gap 13, the radially inner lubricating gap 14 can be supplied with lubricating oil via a second line (not shown) extending through the bearing bush (11).

A wear protection coating can be applied to the radially outer surface of the bearing bush 11, on which the or each spring element 15 supports itself.

The invention can be employed with any type of turbocharger. The invention is independent of the concrete embodiment of the turbine and of the compressor. The invention is also independent of the concrete embodiment of an internal combustion engine interacting with the turbocharger.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turbocharger comprising:
a turbine for expanding a first medium, wherein the turbine comprises a turbine housing and a turbine rotor;
a compressor for compressing a second medium utilizing energy extracted in the turbine during an expansion of the first medium, wherein the compressor comprises a compressor housing and a compressor rotor coupled to the turbine rotor via a shaft;
a bearing housing arranged between the turbine housing and the compressor housing, wherein both the turbine housing and the compressor housing are connected to the bearing housing;
at least one bearing, for mounting the shaft in the bearing housing, wherein the bearing comprises a bearing bush mounted in the bearing housing in a rotationally fixed manner,
a radially outer lubricating gap formed between the bearing bush and the bearing housing and a radially inner lubricating gap formed between the bearing bush and the shaft; and
at least one spring element for aligning the bearing bush of the bearing in a radial direction relative to the bearing housing.

2. The turbocharger according to claim 1, wherein the bearing housing comprises a groove having a groove base, and wherein the respective spring element is inserted into the groove so as to support itself on one side on the groove base and on another side on a radially outer surface of the bearing bush.

3. The turbocharger according to claim 1, wherein the respective spring element is designed as circumferential blade spring in the respective groove.

4. The turbocharger according to claim 1, wherein the spring element is designed as circumferential disc spring in the respective groove.

5. The turbocharger according to claim 1, wherein a first spring element acts on a first axial end section and a second spring element acts on a second axial end section of the bearing bush so that the bearing bush is aligned in the radial direction relative to the bearing housing via the spring elements.

6. The turbocharger according to claim 2, wherein the radially outer lubricating gap is supplied with lubricating oil from at least one first line which opens into the radially outer lubricating gap between the grooves receiving the spring elements.

7. The turbocharger according to claim 6, wherein the radially inner lubricating gap is supplied with lubricating oil emanating from the radially outer lubricating gap.

8. The turbocharger according to claim 2, wherein the spring element is designed as circumferential blade spring in the respective groove.

9. The turbocharger according to claim 2, wherein the spring element is designed as circumferential disc spring in the respective groove.
